(19) United States
(12) Patent Application Publication
(10) Pub. No.: US 2012/0322708 A1
(43) Pub. Date: Dec. 20, 2012

(54) CONSUMER PRODUCTS

(76) Inventors: Neil Joseph LANT, Newcastle upon Tyne (GB); Philip Frank Souter, Morpeth (GB); Ole Simonsen, Soeborg (DK); Carsten Hoerslev Hansen, Vaerloese (DK); Luise Erlandsen, Frederikssund (DK)

(21) Appl. No.: 13/492,979

(22) Filed: Jun. 11, 2012

(30) Foreign Application Priority Data
Jun. 20, 2011 (EP) 11170618.0

(51) Int. Cl. C11D 3/60; C11D 17/08

(52) U.S. Cl. 510/101; 510/392; 510/374; 510/320

(57) ABSTRACT

Compositions including bleach components and sensitive components providing a means for separating and therefore protecting sensitive components. The sensitive component is introduced via a protected particle including a substrate for an enzyme also present in the composition.

### FIELD OF INVENTION

This invention relates to cleaning compositions comprising bleach components and sensitive components and provides a means for separating and therefore protecting sensitive components.

### BACKGROUND OF THE INVENTION

Detergent manufacturers continue to try to provide cleaning compositions, particularly fabric and dish-cleaning compositions which provide the most robust cleaning systems over a wide variety of soil and stain types. Whilst it is desirable to incorporate bleach components these can interact with other components in the cleaning composition during storage or on initial contact with solvent, usually water, for dissolving or dispersing the compositions. This leads to loss of activity or efficacy of the other component(s). Particular examples of sensitive components include perfumes, dyes, optical brighteners and enzymes. Certain bleach components are particularly problematic, such as pre-formed peracids and bleach catalysts or boosters. There remains a need for a composition which alleviates this problem. In addition to offering protection, it may be important that the protective means enables release of the protected component at an appropriate stage of the cleaning process. If the protection is too robust, there is a risk that the protected component cannot be released into the wash water.

WO2009/019075, WO2009/118329, US2001/31714, WO99/37746, WO97/23606, WO95/28469, WO95/28468, WO95/28466, EP390446 all relate to separation of detergent components or controlled release.

### SUMMARY OF THE INVENTION

This invention relates to detergent compositions comprising:

(a) a bleach component,
(b) a protected particle comprising a sensitive component;
(c) a first wash lipid esterase; and
(d) a detergent adjunct,
the protected particle comprising a substrate for the first wash lipid esterase.

In a preferred embodiment, the protected particle comprises (i) a core and (ii) at least a first coating layer; and optional second and further coating layers; at least one of the core or coating layers comprising the sensitive component and at least the core or one or more coating layer which comprises the sensitive component, or a coating layer outermost with respect to the sensitive component, comprising a delayed-release coating comprising the substrate for the first wash lipid esterase.

The invention also provides a method of treating textile, the method comprising the steps of: (i) treating a a textile with an aqueous solution comprising (a) a bleach component, (b) a protected particle comprising a sensitive component; (c) a first wash lipid esterase; and (d) a detergent adjunct, the protected particle comprising a substrate for the first wash lipid esterase.

Preferably, the protected particle comprises (i) a core and (ii) at least a first coating layer; and optional second and further coating layers; at least one of the core or coating layers comprising the sensitive component and at least the core or one or more coating layer which comprises the sensitive component, or a coating layer outermost with respect to the sensitive component, comprising a delayed-release coating comprising a substrate for the first wash lipid esterase.

Preferably at least one coating layer outermost relative to the sensitive component, comprises the substrate for the first wash lipid esterase.

The invention also provides a particulate detergent composition comprising:

a) particles comprising a first bleach component, preferably a source of organic peroxyacids, and
b) particles comprising a second bleach component comprising a bleach catalyst, preferably an organic bleach catalyst; and
c) particles comprising

i) a core comprising an enzyme surrounded by

ii) a delayed-release coating.

The invention also provides a particulate detergent composition comprising:

a) particles comprising a first bleach component, preferably a source of organic peroxyacids, and
b) particles comprising a second bleach component comprising a bleach catalyst, and
c) particles comprising

i) a core comprising a first-wash lipid esterase surrounded by

ii) a delayed-release coating.

### DETAILED DESCRIPTION OF THE INVENTION

### Definitions

As used herein “consumer product” means consumer and institutional products, including but not limited to laundry, dishwashing, and hard surface cleaning products, other cleaners, and cleaning systems all for the care and cleaning of inanimate surfaces, as well as fabric conditioner products and other products designed specifically for the care and maintenance of fabrics, and air care products. Such consumer products are generally intended to be used or consumed in the form in which they are sold.

As used herein, the term “cleaning and/or treatment composition” is a subset of consumer products, such products include, but are not limited to, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use: car or carpet shampoos, bathroom cleaners including toilet bowl cleaners; as well as cleaning auxiliaries such as bleach additives and “stain-stick” or pre-treat types, substrate-laden products such as dryer added sheets.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, car or carpet shampoos, bathroom cleaners including toilet bowl cleaners; fabric conditioning products including softening and/or freshening that may be in liquid, solid and/or dryer sheet form; as well as cleaning auxiliaries such as bleach additives and “stain-stick” or pre-treat types. All of such products which are applicable may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms, including liquids or gels in pouches such as unitized dose form.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

### The Protected Particle

The protected particle comprises a sensitive component. The sensitive component is preferably an enzyme, most preferably comprising a first wash lipid esterase. The protected particle also comprises a substrate for an enzyme in the composition, preferably a substrate for a first wash lipid esterase. The protected particle preferably comprises a core and at least a first coating layer and optional second and further coating layers. At least the core or one or more coating layers comprises the sensitive component. The substrate for the enzyme may be in the core or a coating layer, comprising the sensitive component, but preferably the substrate for the enzyme is present in at least one coating layer outermost relative to the core or coating layer which comprises the sensitive component. Preferably the core comprises the sensitive component.

The core may comprise a pre-formed core such as an inert core upon which the sensitive component is deposited, or a core prepared of porous material on/in which the sensitive component is adsorbed or absorbed. The sensitive component may be incorporated into the core at the same time as the core particle is prepared. In a preferred embodiment the core is prepared by the granulation of filler components in the presence of the sensitive component, and optionally, an additional binder material. Preformed cores may also be called carrier particles: nuclei, placebo nuclei (free of sensitive component) or seeds are inert particles upon which the sensitive component either alone or in admixture with solvent or other carriers or fillers can be deposited. Preformed cores comprise a core material selected from inorganic salts, starch, sugars, sugar alcohols, smallorganic molecules such as organic acids or salts, such as carbonates and/or citrates, minerals such as clays, zeolites, or silicates or mixtures thereof. Suitable binders include water, synthetic polymer, wax, fat or carbohydrate. Suitable fillers comprise fibre materials such as cellulosic or synthetic fibres. The core may optionally comprise stabilizing agents, solubilizing agents, suspension agents, viscosity regulating agents, light spheres, plasticizers, salts and lubricants. Suitable cores are described in for example, U.S. Pat. No. 4,106,991, EP170360, EP304441 and EP304442.

The core may be prepared by granulation, e.g. by use of granulation techniques including: crystallization, precipitation, pan-coating, fluid bed coating, fluid bed agglomeration, rotary atomization, extrusion, prilling, spheronization, size reduction methods, drum granulation and/or high shear granulation.

Preferably the sensitive component is present in the protected particle as part of the core. In this case, the core may consist of inert particles with the sensitive component absorbed into it, or with the sensitive component applied onto the surface e.g. via fluid bed coating.

The core particle may have a diameter from 20-2000 μm, preferably 50-1500 μm or most preferably 100-1500 μm or even 250-2500 μm.

The coating layer(s) substantially encapsulates the sensitive component comprised in the protected particle, thereby providing protection. Thus, the coating layer or combination of coating layer(s) typically provides a substantially continuous coating around the core or layer comprising the sensitive component. By substantially continuous is meant that there should be few or no uncoated areas. The protective effect depends on the thickness of the coating and amount of the coating layer(s). Preferably the outer coating layer does not contain the sensitive component.

The coating layer or combination of coating layers may comprise from 1 to 75 wt % of the protected particle. Typically the coating layer(s) provide from 5 to 50 wt % of the protected particle or preferably 15 to 35 wt % of the protected particle.

### Substrate for the Enzyme

Suitable substrates must be selected according to the enzyme used and will be apparent to a skilled person depending on the enzyme used.

### Substrate for the First Wash Lipid Esterase

The protected particle preferably comprises a substrate for a first wash lipid esterase which therefore must be selected according to the first wash lipid esterase enzyme in the composition. Suitable substrates are selected from carboxylic esters that are hydrolysable by the first wash lipid esterase during an aqueous wash process, or mixtures thereof. Examples of suitable materials include waxes or fats preferably having a melting point greater than 60, preferably above 100 or above 120° C. Examples of suitable materials are lipids, mono-, di- and triglycerides such as tripalmitin, palm oil, beeswax, jojoba oil, carnauba wax, carnauba wax, polyesters, polyester block copolymers such as polyethylene terephthalate/polyoxyethylene terephthalate (PET/POET) block copolymers and polycaprolactone, preferably comprising palm oil. It is straightforward for someone skilled in the art to select appropriate combinations of first-wash lipid esterase with substrate, for example a first-wash triacylglycerol lipases may be paired with a triglyceride such as palm oil, or a cutinase may be paired with a PET/POET block copolymer.

Preferably the protected particle comprises from 1 to 90 wt % substrate for the enzyme, more preferably from 1 to 75 wt % based on the weight of the protected particle. Preferably a coating layer or the combination of coating layers comprises from 1 to 80 wt %, more preferably from 1 to 60 wt %, or 5 to 40 wt %, more preferably from 5 to 15 wt % based on the weight of the coating layer, of substrate for the enzyme, preferably first wash lipid esterase. In addition to a material with sensitivity to the enzyme, preferably first-wash lipid esterase, the coating may also comprise other materials, including non-lipid hydrophobic surfaces such as petroleum waxes, and water insoluble materials such as kaolin, talc or calcium carbonate, e.g. in an amounts of 60-75% by weight. Other suitable coating layers and components and processes for applying a coating layer are described for example in U.S. Pat. No. 4,106,991, WO92/12645 or WO97/16076.

The release profile for the sensitive component, which is preferably an enzyme, in the protected particle is preferably such that the time required to release 50% of the sensitive component is at least 100 seconds, at least 200 seconds or at least 300 seconds. The time required to release 50% or 90% of the sensitive component for the protected particle is preferably at least 1.5 times, at least 2 times or at least 3 times longer than the time required for release of an otherwise similar particle without a delayed-release coating. The test to determine whether these values are met for a sensitive component comprising an enzyme, based on release of enzyme activity is defined as Test Method 2: Dissolution test, below.

In addition to a core or coating layer comprising the substrate for the enzyme, preferably comprised in a delayed-release coating, the protected particles may optionally comprise one or more additional coatings, either as an undercoat or a topcoat, e.g. to reduce dust formation. In a preferred embodiment of the invention, such a coating may comprise polyethylene glycol (PEG), polyvinyl alcohol (PVA) or hydroxypropyl methyl cellulose (HPMC).

### Process for Producing the Protected Particle

The protected particle may be prepared by combinations of processing steps known to those skilled in the art of granulation, including mixer granulation, fluid bed coating, prilling, disc granulation, pan drum coating, spray drying, extrusion, fluid bed spray drying, high shear agglomeration, spheronization or combinations of these techniques. Particles may comprise layered products, absorbed products, pelletized products, and prilled products. The particles may optionally be dried after granulation. The particles may further be sieved after granulation.

Methods for preparing the particle or particle core can be found in Handbook of Powder Technology; Particle size enlargement by C. E. Capes; Volume 1; 1980; Elsevier. Preparation methods include known granulation technologies:

a) Spray dried products, wherein a sensitive component-containing solution is atomized in a spray drying tower to form small droplets which during their way down the drying tower dry to form a sensitive component-containing particulate material. Very small particles can be produced this way (Michael S. Showell (editor); Powdered detergents; Surfactant Science Series; 1998; vol. 7 1; page 140-142; Marcel Dekker).

b) Layered products, wherein the sensitive-component is coated as a layer around a pre-formed inert core particle, wherein an sensitive component-containing solution is atomized, typically in a fluid bed apparatus wherein the pre-formed core particles are fluidized, and the sensitive component-containing solution adheres to the core particles and dries up to leave a layer of dry active component on the surface of the core particle. Particles of a desired size can be obtained this way if a useful core particle of the desired size can be found. This type of product is described in, for example, WO 97/23606.

c) Absorbed core particles, wherein rather than coating the sensitive component as a layer around a core, the sensitive component is absorbed onto and/or into the surface of the core. Such a process is described in WO 97/39116.

d) Extrusion or pelletized products, wherein a sensitive component-containing paste is pressed to pellets or under pressure is extruded through a small opening and cut into particles which are subsequently dried. Such particles usually have a considerable size because of the material in which the extrusion opening is made (usually a plate with bore holes) sets a limit on the allowable pressure drop over the extrusion opening. (Michael S. Showell (editor); Powdered detergents; Surfactant Science Series; 1998; vol. 71; page 140-142; Marcel Dekker).

e) Prilled products, wherein a sensitive component in form of a powder is suspended in molten wax and the suspension is sprayed, e.g. through a rotating disk atomiser, into a cooling chamber where the droplets quickly solidify (Michael S. Showell (editor); Powdered detergents; Surfactant Science Series; 1998; vol. 71; page 140-142; Marcel Dekker). The product obtained is one wherein the sensitive component is uniformly distributed throughout an inert material instead of being concentrated on its surface. Also U.S. Pat. No. 4,016,040 and U.S. Pat. No. 4,713,245 are documents relating to this technique.

f) Mixer granulation products, wherein a sensitive component-containing liquid is added to a dry powder composition of conventional granulating components. The liquid and the powder in a suitable proportion are mixed and as the moisture of the liquid is absorbed in the dry powder, the components of the dry powder will start to adhere and agglomerate and particles will build up, forming granulates comprising the sensitive component. Such a process is described in U.S. Pat. No. 4,106,991 (Novozymes) and related documents EP 170360 B1 (Novozymes), EP 304332 B1 (Novozymes), EP 304331 (Novozymes), WO 90/09440 (Novozymes) and WO 90/09428 (Novozymes).

g) Size reduction, wherein the cores are produced by milling or crushing of larger par tides, pellets, tablets, briquettes etc. containing the rinse sensitive component. The wanted core particle fraction is obtained by sieving the milled or crushed product. Over and undersized particles can be recycled. Size reduction is described in (Martin Rhodes (editor); Principles of Powder Technology; 1990; Chapter 10; John Wiley & Sons).

h) Fluid bed granulation. Fluid bed granulation involves suspending particulates in an air stream and spraying a liquid onto the fluidized particles via nozzles. Particles hit by spray droplets get wetted and become tacky. The tacky particles collide with other particles and ad here to them and form a granule.

i) The cores and particles may be subjected to drying, such as in a fluid bed drier.

Other known methods for drying granules in the feed or enzyme industry can be used by the skilled person. The drying preferably takes place at a product temperature of from 25 to 90° C. After drying, the cores preferably contain 0.1-10% w/w water.

Layers may be applied onto the partially-formed particle comprising the sensitive component by atomization onto the particles in a fluid bed or a fluid bed spray dryer, the layers may further be applied in mixers, dragee type coaters (pan-drum coaters), equipment for coating of seeds, equipment comprising rotating bottoms (e.g. Roto Glatt, CF granulators (Freund), torbed processors (Gauda) or in rotating fluid bed processors such as Omnitex (Nara).

After applying the coating layer the particle may optionally be dried. The drying of the particle can be achieved by any drying method available to the skilled person, such as spray-drying, freeze drying, vacuum drying, fluid bed drying, pan drum coating and microwave dry ing. Drying of the particle can also be combined with granulation methods which comprise e.g. the use of a fluid bed, a fluid bed spray dryer (FSD) or a Multi-stage dryer (MSD).

Conventional coatings and methods as known to the art may suitably be used, such as the coatings described in Danish PA 2002 00473, WO 89/08694, WO 89/08695, 270 608 B1 and/or WO 00/01 793. Other examples of conventional coating materials may be found in U.S. Pat. No. 4,106,991, EP 170360, EP 304332, EP 304331, EP 458849, EP 458845, WO 97/391 16, WO 92/12645A, WO 89/08695, WO 89/08694, WO 87/07292, WO 91/06638, WO 92/13030, WO 93/07260, WO 93/07263, WO 96/38527, WO 96/16151, WO 97/23606, WO 01/25412, WO 02/20746, WO 02/28369, U.S. Pat. No. 5,879,920, U.S. Pat. No. 5,324,649, U.S. Pat. No. 4,689,297, U.S. Pat. No. 6,348,442, EP 206417, EP 193829, DE 434421 5, DE 4322229 A, DE 263790, JP 61162185 A and/or JP 58179492.

If compatible with the sensitive component and the substrate for the enzyme, the substrate coating may be applied via melt coating in a fluid bed. This method is well known in the art. The melted coating material is sprayed onto the cores in a fluidized bed. The fluidization gas has a temperature below the solidification temperature of the coating material (see e.g. “Fluid Bed Coating” by Teunou & Poncelet in “Encapsulated And Powdered Foods”, edited by Onwulata, CRC Press 2005).

In a preferred embodiment the process for preparing the protected particle of the invention comprises the steps of:

a) Preparing a core comprising a sensitive component by granulation. Additional materials which may be present in the core include binders (such as synthetic polymer, wax, fat or carbohydrate). The core may further include additional materials such as fillers, fibre materials (cellulose or synthetic fibres), stabilizing agents, solubilising agents, suspending agents, viscosity regulating agents, light spheres, plasticisers, salts, lubricants and perfumes. Within the core, the sensitive component may be present within or adsorbed onto, another inert particle. The core particle may have a diameter of 20-2000 μm, particularly 50-1500 μm, 100-1500 μm or 250-1200 μm;

b) Optionally applying one or more protective layers onto the core of a);

c) Applying a layer comprising a material with sensitivity to first-wash lipid esterase.

Optional further coating: The particle may comprise further layers or coatings besides the coating layer to provide further improved properties of the particle.

Optionally, the particles may be pre-coated by applying a protective pre-coat to cores comprising the sensitive component before applying the coating with sensitivity to first-wash lipid esterase. The pre-coat may serve to protect and retain the sensitive component during the further processing and may consist, e.g., of a fat or oil.

It will be seen from the above that according to a preferred embodiment of the invention the sensitive-component may be present in the core or a coating layer, but preferably has at least one coating layer outermost. Although the sensitive component and substrate for the first wash lipid esterase may be in the core together or may be provided both in the core or both in a single coating layer, preferably the sensitive component is present in the core of the protected particle and the substrate for the first wash lipid esterase is in a coating layer outermost to the core.

In a preferred embodiment of the invention the substrate for the first wash lipid esterase is in provided in the outer coating layer of the protected particle. In this case it may be particularly preferred to have a first wash lipid esterase present in the composition outside the protected particle. In a preferred embodiment the sensitive component comprises the enzyme, most preferably first wash lipid esterase.

The protected particle preferably comprises from 0.0001 to 50 wt % sensitive component, preferably from 0.001 to 35 wt % or even 0.01 to 25 wt %.

### Sensitive Component

The sensitive component in the protected particle may be provided by any component which loses activity in the presence of bleach either on storage or in aqueous solution, particularly water for washing. Sensitive components are particularly dyes, particularly fabric hueing dyes, optical brighteners, perfume components in particular perfumes having a hydrolysable ester group, and enzymes. Particularly preferred sensitive components are dyes, brighteners and enzymes, most preferably enzymes.

### Sensitivity of Enzyme to Bleach Catalyst

The sensitive component is particularly preferably an enzyme which is sensitive to a bleach component, particularly a bleach catalyst. The sensitivity is determined by testing the wash performance of the enzyme on fatty soiling in a detergent containing the bleach component or combination thereof, and comparing with the performance in a similar detergent without the bleach component or combination thereof. The enzyme is considered sensitive if the ratio of wash performance without and with bleach component or combination thereof is more than 2, particularly more than 5. The fabric hueing agent (also defined herein as hueing dye) is typically formulated to deposit onto fabrics from the wash liquor so as to improve fabric whiteness perception. The fabric hueing agent is typically blue or violet. It may be suitable that the hueing dye(s) have a peak absorption wavelength of from 550 nm to 650 nm, or from 570 nm to 630 nm. The fabric hueing agent may be a pigment or a dye or combination of dyes and/or pigments which together have the visual effect on the human eye as a single dye having a peak absorption wavelength on polyester of from 550 nm to 650 nm, or from 570 nm to 630 nm. This may be provided for example by mixing a red and green-blue dye to yield a blue or violet shade.

Dyes are typically coloured organic molecules which are soluble in aqueous media that contain surfactants. Dyes may be selected from the classes of basic, acid, hydrophobic, direct and polymeric dyes, and dye-conjugates. Suitable polymeric hueing dyes are commercially available, for example from Milliken, Spartanburg, S.C., USA. Suitable fabric hueing agents include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, Solvent Red, Blue and Violet dyes or mixtures thereof.

Examples of suitable dyes are violet DD, direct violet 7, direct violet 9, direct violet 11, direct violet 26, direct violet 31, direct violet 35, direct violet 40, direct violet 41, direct violet 51, direct violet 66, direct violet 99, acid violet 50, acid blue 9, acid violet 17, acid black 1, acid red 17, acid blue 29, solvent violet 13, disperse violet 27 disperse violet 26, disperse violet 28, disperse violet 63 and disperse violet 77, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141, thiazolium dyes, reactive blue 19, reactive blue 163, reactive blue 182, reactive blue 96, Liquitint® Violet CT (Milliken, Spartanburg, USA) and Azo-CM-Cellulose (Megazyme, Bray, Republic of Ireland). Other suitable fabric hueing agents are hueing dye-photobleach conjugates, such as the conjugate of sulphonated zinc phthalocyanine with direct violet 99. A particularly suitable fabric hueing agent is a combination of acid red 52 and acid blue 80, or the combination of direct violet 9 and solvent violet 13.

Other examples of suitable fabric hueing agents are described in more detail below under the sub-heading “Detegent adjuncts”.

Suitable optical brighteners are described below at “Brighteners” under the sub-heading “Detergent adjuncts”.

Particularly preferred sensitive components according to the invention are enzymes. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. Particularly preferred as the sensitive component are enzymes selected from first wash lipid esterases.

### Enzyme

The enzyme may in particular be an enzyme which is sensitive to the bleach component. The enzyme may be an amylase, a carbohydrase, a protease, a lipolytic enzyme, a cellulase, an oxidoreductase, a mannanase or a pectate lyase.

Preferably the enzyme is present in the composition in amounts from 0.00001% to 2%, more preferably from to 0.0001% to 0.02%, most preferably from 0.001% to 0.01%.

### First Wash Lipid Esterase

The first wash lipid esterase may be selected from the following:

(1) Triacylglycerol lipases (E.C. 3.1.1.1) exhibiting first wash activity

(2) Cutinase (E.C. 3.1.1.74)

(3) Sterol esterase (E.C. 3.1.1.13)

(4) Wax-ester hydrolase (E.C. 3.1.1.50)

A suitable protocol for determining whether a triacylglycerol lipase exhibits first wash activity is given in Test Method 1. The lipolytic enzyme (or lipid esterase) is an enzyme in class EC 3.1.1 as defined by Enzyme Nomenclature. It may have lipase activity (triacylglycerol lipase, EC 3.1.1.3), cutinase activity (EC 3.1.1.74), sterol esterase (EC 3.1.1.13), and/or wax-ester hydrolase activity (EC 3.1.1.50).

The lipolytic enzyme may in particular be a lipase with first-wash activity as described in WO9707202 and WO 00/60063. Suitable triacylglycerol lipases exhibiting first wash activity can be selected from variants of the Humicola lanuginosa (Thermomyces lanuginosus) lipase, such as Lipex™, Lipolex™ and Lipoclean,™ all products of Novozymes, Bagsvaerd, Denmark. Preferred first wash lipases are described in WO2006/090335, most preferably the first wash lipase is selected from Humicola lanuginosa lipase variants with mutations T231R and N233R. Other suitable first wash lipases can be selected from variants of Pseudomonas lipases, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), Bacillus lipases, e.g., from B. subtilis (Dartois et al. (1993), Biochemica et Biophysica Acta, 1131, 253-360), B. stearothermophilus (JP 64/744992) or B. pumilus (WO 91/16422).

Suitable cutinases may be derived from a strain of Aspergillus, in particular Aspergillus oryzae, a strain of Alternaria, in particular Alternaria brassiciola, a strain of Fusarium, in particular Fusarium solani, Fusarium solani pisi, Fusarium oxysporum, Fusarium oxysporum cepa, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, a strain of Coprinopsis, in particular Coprinopsis cinerea, a strain of Thermobifida, in particular Thermobilida fusca, a strain of Magnaporthe, in particular Magnaporthe grisea, or a strain of Ulocladium, in particular Ulocladium consortiale.

In a preferred embodiment, the cutinase is selected from variants of the Pseudomonas mendocina cutinase described in WO 2003/076580 (Genencor), such as the variant with three substitutions at 1178M, F180V, and S205G.

In another preferred embodiment, the cutinase is a wild-type or variant of the six cutinases endogenous to Coprinopsis cinerea described in H. Kontkanen et al, App. Environ. Microbiology, 2009, p 2148-2157

In another preferred embodiment, the cutinase is a wild-type or variant of the two cutinases endogenous to Trichoderma reesei described in WO2009007510 (VTT).

In a most preferred embodiment the cutinase is derived from a strain of Humicola insolens, in particular the strain Humicola insolens DSM 1800. Humicola insolens cutinase is described in WO 96/13580 which is hereby incorporated by reference. The cutinase may be a variant, such as one of the variants disclosed in WO 00/34450 and WO 01/92502. Preferred cutinase variants include variants listed in Example 2 of WO 01/92502. Preferred commercial cutinases include Novozym 51032 (available from Novozymes, Bagsvaerd, Denmark).

Suitable sterol esterases may be derived from a strain of Ophiostoma, for example Ophiostoma piceae, a strain of Pseudomonas, for example Pseudomonas aeruginosa, or a strain of Melanocarpus, for example Melanocarpus albomyces.

In a most preferred embodiment the sterol esterase is the Melanocarpus albomyces sterol esterase described in H. Kontkanen et al, Enzyme Microb Technol., 39, (2006), 265-273.

Suitable wax-ester hydrolases may be derived from Simmondsia chinensis.

### Amylase

The amylase may be an -amylase obtained from Bacillus, e.g. B. subtilis and B. licheniformis, in particular the amylase from a special strain of B. licheniformis, described in more detail in GB 1,296,839.

Examples of useful amylases are described in WO 94/02597, WO 94/18314, WO 1995/010603, WO 1995/026397, WO 96/23873, WO 97/43424, and WO 00/60060, WO 2001/066712, WO 2006/002643, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

In a particular embodiment the alpha-amylase is derived from Bacillus sp. strains NCIB 12289, NCIB 12512, NCIB 12513 and DSM 9375. Especially preferred are the alpha-amylases shown in SEQ ID NOS 1 and 2 of WO 95/26397.

Commercially available amylases are NATALASE™, STAINZYME™, STAINZYME PLUS™, TERMAMYL™ ULTRA, DURAMYL™, TERMAMYL™, FUNGAMYL™ and BAN™ (Novozymes A/S), RAPIDASE™ PURASTAR™ and PURASTAR OXAM™ (from Genencor International Inc.).

### Protease

Suitable proteases include those of animal, vegetable or microbial origin. Microbial origin is preferred. Chemically modified or protein engineered mutants are included. The protease may be a serine protease or a metalloprotease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Preferred commercially available protease enzymes include Alcalase™, Savinase™ Primase™, Duralase™, Esperase™, and Kannase™ (Novozymes A/S), Maxatase™, Maxacal™ Maxapem™, Properase™, Purafect™, Purafect OxP™, FN2™, and FN3™ (Genencor International Inc.).

### Cellulase

Suitable cellulases include complete cellulases or mono-component endoglucanases of bacterial or fungal origin. Chemically or genetically modified mutants are included. The cellulase may for example be a mono-component or a mixture of mono-component endo-1,4-beta-glucanase often just termed endoglucanases (EC 3.2.1.4). Some xyloglucanases may also have endoglucanase activity and are also considered as suitable cellulases in the present invention. Suitable cellulases are disclosed in U.S. Pat. No. 4,435,307, which discloses fungal cellulases produced from Humicola insolens. Especially suitable cellulases are the cellulases having textile care benefits. Examples of such cellulases are cellulases described in European patent application No. 0 495 257.

Suitable mono-component endoglucanases may be obtained from one or more of the following species Exidia glandulosa, Crinipellis scabella, Fomes fomentarius, Spongipellis sp., Rhizophlyctis rosea, Rhizomucor pusillus, Phycomyces nitens, and Chaetostylum fresenii, Diplodia gossypina, Microsphaeropsis sp., Ulospora bilgramii, Aureobasidium sp., Macrophomina phaseolina, Ascobolus stictoides, Saccobolus dilutellus, Peziza, Penicillium verruculosum, Penicillium chrysogenum, and Thermomyces verrucosus, Trichoderma reesei aka Hypocrea jecorina, Diaporthe syngenesia, Colletotrichum lagenarium, Xylaria hypoxylon, Nigrospora sp., Nodulisporum sp., and Poronia punctata, Cylindrocarpon sp., Nectria pinea, Volutella colletotrichoides, Sordaria fimicola, Sordaria macrospora, Thielavia thermophila, Syspastospora boninensis, Cladorrhinum foecundissimum, Chaetomium murorum, Chaetomium virescens, Chaetomium brasiliensis, Chaetomium cunicolorum, Myceliophthora thermophila, Gliocladium catenulatum, Scytalidium thermophila, Acremonium sp Fusarium solani, Fusarium anguioides, Fusarium poae, Fusarium oxysporum ssp. lycopersici, Fusarium oxysporum ssp. passiflora, Humicola nigrescens, Humicola grisea, Fusarium oxysporum, Thielavia terrestris or Humicola insolens. One preferred endoglucanase is disclosed in WO 96/29397 as SEQ ID NO: 9 (hereby incorporated by reference) or an enzyme with at least 70% identity thereto and variants thereof as disclosed in Example 1 of WO 98/12307. Another preferred endoglucanase is disclosed in WO 91/017243 (SEQ ID NO:2) or endoglucanases variants as disclosed in WO 94/007998.

Endoglucanases with an anti-redeposition effect may be obtained from fungal endoglucanases lacking a carbohydrate-binding module (CBM) from a number of bacterial sources. Some sources are Humicola insolens, Bacillus sp. deposited as DSM 12648, Bacillus sp. KSMS237 deposited as PERM P-16067, Panibacillus polymyxa, and Panibacillus pabuli. Specific anti-redeposition endoglucanase are disclosed in WO 91/17244 (FIG. 14) (hereby incorporated by reference), WO 2002/099091 position 1-773 of SEQ ID NO: 2 (hereby incorporated by reference), WO 04/053039 SEQ ID NO: 2 (hereby incorporated by reference), JP 2000210081 position 1 to 824 of SEQ ID NO: 1 (hereby incorporated by reference).

Xyloglucanases with an anti-redeposition effect may be obtained from a number of bacterial sources. Some sources are Bacillus lichenifonnis, Bacillus agaradhaerens, (WO 99/02663) Panibacillus polymyxa, and Panibacillus pabuli (WO01/62903). Suitable variants of xyloglucanases are also described in PCT/EP2009/056875. A commercially available xyloglucanase is Whitezyme® (Novozymes A/S).

Commercially available cellulases include Celluclast® produced from Trichoderma reesei, Celluzyme® produced from Humicola insolens. Commercially available endoglucanases are Carezyme®, Renozyme®, Endolase® and Celluclean® (Novozymes A/S), and KAC-500(B)™ (Kao Corporation) and Clazinase™, Puradax™ EG L and Puradax HA (Danisco A/S).

### Pectate Lyase

The pectate lyase may be a wild-type enzymes derived from Bacillus, particularly B. lichermformis or B. agaradhaerens, or a variant derived of these, e.g. as described in U.S. Pat. No. 6,124,127 (NZ 5543), WO 1999/027083 (NZ 5377), WO 1999/027084 (NZ 5378), WO 2002/006442 (NZ 10044), WO 2002/092741 (NZ 10171), or WO 2003/095638 (NZ 10190).

### Mannanase

The mannanase may be an alkaline mannanase of Family 5 or 26. It may be a wild-type from Bacillus or Humicola, particularly B. agaradhaerens, B. lichenifonnis, B. halodurans, B. clausii, or H. insolens. Suitable mannanases are described in WO 1999/064619 (NZ 5440).

Preferably the first wash lipid esterase is present in the composition in amounts from 0.00001% to 2%, more preferably from to 0.0001% to 0.02%, most preferably from 0.001% to 0.01%

In a preferred embodiment of the invention the first wash lipid esterase is the sensitive component, optionally in combination with additional further sensitive components.

### Bleach Component

The cleaning compositions of the present invention comprises one or more bleach components. Suitable bleach components include bleaching catalysts, photobleaches, bleach activators, hydrogen peroxide, sources of hydrogen peroxide, pre-formed peracids and mixtures thereof. In general, when a bleach component is used, the compositions of the present invention may comprise from about 0.001 to 50 wt %, preferably 0.1% to about 50% or even from about 0.1% to about 25% bleach component by weight of the subject cleaning composition. Examples of suitable bleach components include:

(1) Pre-formed peracids: Suitable preformed peracids include, but are not limited to, compounds selected from the group consisting of pre-formed peroxyacids or salts thereof, typically either a peroxycarboxylic acid or salt thereof, or a peroxysulphonic acid or salt thereof.

The pre-formed peroxyacid or salt thereof is preferably a peroxycarboxylic acid or salt thereof, typically having a chemical structure corresponding to the following chemical formula:

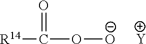

wherein: R¹⁴ is selected from alkyl, aralkyl, cycloalkyl, aryl or heterocyclic groups; the R¹⁴ group can be linear or branched, substituted or unsubstituted; and Y is any suitable counter-ion that achieves electric charge neutrality, preferably Y is selected from hydrogen, sodium or potassium. Preferably, R¹⁴ is a linear or branched, substituted or unsubstituted C₆₋₉ alkyl. Preferably, the peroxyacid or salt thereof is selected from peroxyhexanoic acid, peroxyheptanoic acid, peroxyoctanoic acid, peroxynonanoic acid, peroxydecanoic acid, any salt thereof, or any combination thereof. Preferably, the peroxyacid or salt thereof has a melting point in the range of from 30° C. to 60° C.

The pre-formed peroxyacid or salt thereof can also be a peroxysulphonic acid or salt thereof, typically having a chemical structure corresponding to the following chemical formula:

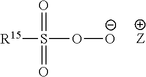

wherein: R¹⁵ is selected from alkyl, aralkyl, cycloalkyl, aryl or heterocyclic groups; the R¹⁵ group can be linear or branched, substituted or unsubstituted; and Z is any suitable counter-ion that achieves electric charge neutrality, preferably Z is selected from hydrogen, sodium or potassium. Preferably R¹⁵ is a linear or branched, substituted or unsubstituted C₆₋₉ alkyl.

(2) Sources of hydrogen peroxideinclude for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts such as those selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(3) Suitable bleach activators include those having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof. When present, the peracid and/or bleach activator is generally present in the consumer product in an amount of from about 0.1 to about 60 wt %, from about 0.5 to about 40 wt % or even from about 0.6 to about 10 wt % based on the fabric and home care product. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

(4) Diacyl peroxides—preferred diacyl peroxide bleaching species include those selected from diacyl peroxides of the general formula:

R¹—C(O)—OO—(O)C—R²

in which R¹ represents a C₆-C₁₈ alkyl, preferably C₆-C₁₂ alkyl group containing a linear chain of at least 5 carbon atoms and optionally containing one or more substituents (e.g. —N⁺(CH₃)₃, —COOH or —CN) and/or one or more interrupting moieties (e.g. —CONH— or —CH═CH—) interpolated between adjacent carbon atoms of the alkyl radical, and R² represents an aliphatic group compatible with a peroxide moiety, such that R¹ and R² together contain a total of 8 to 30 carbon atoms. In one preferred aspect R¹ and R² are linear unsubstituted C₆-C₁₂ alkyl chains. Most preferably R¹ and R² are identical. Diacyl peroxides, in which both R¹ and R² are C₆-C₁₂ alkyl groups, are particularly preferred. Preferably, at least one of, most preferably only one of, the R groups (R₁ or R₂), does not contain branching or pendant rings in the alpha position, or preferably neither in the alpha nor beta positions or most preferably in none of the alpha or beta or gamma positions. In one further preferred embodiment the DAP may be asymmetric, such that preferably the hydrolysis of R1 acyl group is rapid to generate peracid, but the hydrolysis of R2 acyl group is slow.

The tetraacyl peroxide bleaching species is preferably selected from tetraacyl peroxides of the general formula:

R³—C(O)—OO—C(O)—(CH₂)n-C(O)—OO—C(O)—R³

in which R³ represents a C₁-C₉ alkyl, preferably C₃-C₇, group and n represents an integer from 2 to 12, preferably 4 to 10 inclusive.

Preferably, the diacyl and/or tetraacyl peroxide bleaching species is present in an amount sufficient to provide at least 0.5 ppm, more preferably at least 10 ppm, and even more preferably at least 50 ppm by weight of the wash liquor. In a preferred embodiment, the bleaching species is present in an amount sufficient to provide from about 0.5 to about 300 ppm, more preferably from about 30 to about 150 ppm by weight of the wash liquor.

Bleach Catalysts (5 and 6 Below)

Bleach Catalysts may be provided by: non-metal bleach catalysts, catalytic metal complexes or ligands which form catalytic metal complexes. The bleach catalyst is typically present in the composition in an amount which provides 0.001-0.02 g of active material per 1 of wash liquor.

(5) Suitable organic (non-metal) bleach catalysts include bleach catalyst capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulphonate, prepared as described in U.S. Pat. No. 5,360,569 (see, for example, Column 11, Example 1); and N-octyl-3,4-dihydroisoquinolinium p-toluene sulphonate, prepared as described in U.S. Pat. No. 5,360,568 (see, for example, Column 10, Example 3).

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); N[2-(sulphooxy)dodecyl]-3,4-dihydroisoquinolinium, inner salt, prepared as described in U.S. Pat. No. 5,817,614 (see, for example, Column 32, Example V); 2-[3-[(2-ethylhexyl)oxy]-2-(sulphooxy)propyl]-3,4-dihydroisoquinolinium, inner salt, prepared as described in WO05/047264 (see, for example, page 18, Example 8), and 2-[3-[(2-butyloctyl)oxy]-2-(sulphooxy)propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy)decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70.

Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Example 2).

Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Example 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof. Preferably, the bleach catalyst has a chemical structure corresponding to the following chemical formula

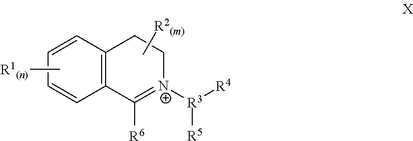

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R³ is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}—[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubstituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can=0 or 1, but c must=0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

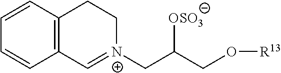

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

(6) Catalytic Metal Complexes—The bleach component may be provided by a catalytic metal complex. One type of catalytic metal complex is a is a metal-containing bleach catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (U.S. Pat. No. 7,501,389) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in U.S. Pat. No. 6,225,464 and WO 00/32601.

Ligands which form Catalytic Metal Complexes

Particularly ligands such as those described above, which form a complex with a transition metal. Formation of such catalytic metal complexes from suitable ligands is described, for example in EP1109965, EP1259522, EP 1240378 and EP 1240379.

(7) Photobleaches—suitable photobleaches include for example sulfonated zinc phthalocyanine sulfonated aluminium phthalocyanines, xanthene dyes and mixtures thereof; Preferred bleach components for use in the present compositions of the invention comprise a hydrogen peroxide source, bleach activator and/or organic peroxyacid, optionally generated in situ by the reaction of a hydrogen peroxide source and bleach activator, in combination with a bleach catalyst. Preferred bleach components comprise bleach catalysts, preferably organic bleach catalysts, as described above.

### Detergent Adjunct

The compositions of the present invention comprise one or mixtures of more than one detergent adjuncts. Non-limiting examples are listed hereinafter and may be desirably incorporated in certain embodiments of the invention, for example to assist or enhance cleaning performance, for treatment of the substrate to be cleaned, or to modify the aesthetics of the consumer product as is the case with perfumes, colorants, dyes or the like. The levels of any such adjuncts incorporated in any fabric and home care product are in addition to any materials previously recited for incorporation. The precise nature of these additional components, and levels of incorporation thereof, will depend on the physical form of the consumer product and the nature of the cleaning operation for which it is to be used. Suitable detergent adjuncts include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, hueing dyes, perfumes, perfume delivery systems, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

However, when one or more adjuncts are present, such one or more adjuncts may be present as detailed below:

### Suitable Fabric Hueing Agents

The composition may comprise a fabric hueing agent. Suitable fabric hueing agents are described above under as they may be incorporated into the compositions of the invention as sensitive components. They include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, and Solvent Blue, Red or Violet dyes or mixtures thereof.

In another aspect, suitable small molecule dyes include small molecule dyes selected from the group consisting of Colour Index (Society of Dyers and Colourists, Bradford, UK) numbers Direct Violet 9, Direct Violet 35, Direct Violet 48, Direct Violet 51, Direct Violet 66, Direct Violet 99, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Red 52, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159 and mixtures thereof. In another aspect, suitable small molecule dyes include small molecule dyes selected from the group consisting of Colour Index (Society of Dyers and Colourists, Bradford, UK) numbers Acid Violet 17, Acid Violet 43, Acid Red 52, Acid Red 73, Acid Red 88, Acid Red 150, Acid Blue 25, Acid Blue 29, Acid Blue 45, Acid Blue 113, Acid Black 1, Direct Blue 1, Direct Blue 71, Direct Violet 51 and mixtures thereof. In another aspect, suitable small molecule dyes include small molecule dyes selected from the group consisting of Colour Index (Society of Dyers and Colourists, Bradford, UK) numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing conjugated chromogens (dye-polymer conjugates) and polymers with chromogens co-polymerized into the backbone of the polymer and mixtures thereof.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® (Milliken, Spartanburg, S.C., USA) Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used). Suitable fabric hueing agents can be purchased from Aldrich, Milwaukee, Wis., USA; Ciba Specialty Chemicals, Basel, Switzerland; BASF, Ludwigshafen, Germany; Dayglo Color Corporation, Mumbai, India; Organic Dyestuffs Corp., East Providence, R.I., USA; Dystar, Frankfurt, Germany; Lanxess, Leverkusen, Germany; Megazyme, Wicklow, Ireland; Clariant, Muttenz, Switzerland; Avecia, Manchester, UK and/or made in accordance with the examples contained herein. Suitable fabric hueing agents are described in more detail in U.S. Pat. No. 7,208,459 B2.

### Encapsulates

The composition may comprise an encapsulate. In one aspect, an encapsulate comprising a core, a shell having an inner and outer surface, said shell encapsulating said core.

In one aspect of said encapsulate, said core may comprise a material selected from the group consisting of perfumes; brighteners; dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

In one aspect of said encapsulate, said core may comprise perfume.

In one aspect of said encapsulate, said shell may comprise melamine formaldehyde and/or cross linked melamine formaldehyde.

In a one aspect, suitable encapsulates may comprise a core material and a shell, said shell at least partially surrounding said core material, is disclosed. At least 75%, 85% or even 90% of said encapsulates may have a fracture strength of from about 0.2 MPa to about 10 MPa, from about 0.4 MPa to about 5 MPa, from about 0.6 MPa to about 3.5 MPa, or even from about 0.7 MPa to about 3 MPa; and a sensitive component leakage of from 0% to about 30%, from 0% to about 20%, or even from 0% to about 5%.

In one aspect, at least 75%, 85% or even 90% of said encapsulates may have a particle size of from about 1 microns to about 80 microns, about 5 microns to 60 microns, from about 10 microns to about 50 microns, or even from about 15 microns to about 40 microns.

In one aspect, at least 75%, 85% or even 90% of said encapsulates may have a particle wall thickness of from about 30 nm to about 250 nm, from about 80 nm to about 180 nm, or even from about 100 nm to about 160 nm.

In one aspect, said encapsulates' core material may comprise a material selected from the group consisting of a perfume raw material and/or optionally a material selected from the group consisting of vegetable oil, including neat and/or blended vegetable oils including caster oil, coconut oil, cottonseed oil, grape oil, rapeseed, soybean oil, corn oil, palm oil, linseed oil, safflower oil, olive oil, peanut oil, coconut oil, palm kernel oil, castor oil, lemon oil and mixtures thereof; esters of vegetable oils, esters, including dibutyl adipate, dibutyl phthalate, butyl benzyl adipate, benzyl octyl adipate, tricresyl phosphate, trioctyl phosphate and mixtures thereof; straight or branched chain hydrocarbons, including those straight or branched chain hydrocarbons having a boiling point of greater than about 80° C.; partially hydrogenated terphenyls, dialkyl phthalates, alkyl biphenyls, including monoisopropylbiphenyl, alkylated naphthalene, including dipropylnaphthalene, petroleum spirits, including kerosene, mineral oil and mixtures thereof; aromatic solvents, including benzene, toluene and mixtures thereof; silicone oils; and mixtures thereof.

In one aspect, said encapsulates' wall material may comprise a suitable resin including the reaction product of an aldehyde and an amine, suitable aldehydes include, formaldehyde. Suitable amines include melamine, urea, benzoguanamine, glycoluril, and mixtures thereof. Suitable melamines include, methylol melamine, methylated methylol melamine, imino melamine and mixtures thereof. Suitable ureas include, dimethylol urea, methylated dimethylol urea, urea-resorcinol, and mixtures thereof.

In one aspect, suitable formaldehyde scavengers may be employed with the encapsulates, for example, in a capsule slurry and/or added to a consumer product before, during or after the encapsulates are added to such consumer product.

Suitable capsules that can be made by following the teaching of USPA 2008/0305982 A1; and/or USPA 2009/0247449 A1. Alternatively, suitable capsules can be purchased from Appleton Papers Inc. of Appleton, Wis. USA.

In addition, the materials for making the aforementioned encapsulates can be obtained from Solutia Inc. (St Louis, Mo. U.S.A.), Cytec Industries (West Paterson, N.J. U.S.A.), sigma-Aldrich (St. Louis, Mo. U.S.A.), CP Kelco Corp. of San Diego, Calif., USA; BASF AG of Ludwigshafen, Germany; Rhodia Corp. of Cranbury, N.J., USA; Hercules Corp. of Wilmington, Del., USA; Agrium Inc. of Calgary, Alberta, Canada, ISP of New Jersey U.S.A., Akzo Nobel of Chicago, Ill., USA; Stroever Shellac Bremen of Bremen, Germany; Dow Chemical Company of Midland, Mich., USA; Bayer AG of Leverkusen, Germany; Sigma-Aldrich Corp., St. Louis, Mo., USA.

### Polymers

The consumer product may comprise one or more polymers. Examples are carboxymethylcellulose, poly(vinyl-pyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The consumer product may comprise one or more amphiphilic cleaning polymers such as the compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

The consumer product may comprise amphiphilic alkoxylated grease cleaning polymers which have balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure. These may comprise alkoxylated polyalkylenimines, preferably having an inner polyethylene oxide block and an outer polypropylene oxide block.

Carboxylate polymer—The consumer products of the present invention may also include one or more carboxylate polymers such as a maleate/acrylate random copolymer or polyacrylate homopolymer. In one aspect, the carboxylate polymer is a polyacrylate homopolymer having a molecular weight of from 4,000 Da to 9,000 Da, or from 6,000 Da to 9,000 Da.

Soil release polymer—The consumer products of the present invention may also include one or more soil release polymers having a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

Cellulosic polymer—The consumer products of the present invention may also include one or more cellulosic polymers including those selected from alkyl cellulose, alkyl alkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da.

Polyethylene glycol polymer: Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Amine polymer: Suitable amine polymers include polyethylene imine polymers, such as alkoxylated polyalkyleneimines, optionally comprising a polyethylene and/or polypropylene oxide block.

Dye transfer inhibitor polymer: Suitable dye transfer inhibitor (DTI) polymers include polyvinyl pyrrolidone (PVP), vinyl co-polymers of pyrrolidone and imidazoline (PVPVI), polyvinyl N-oxide (PVNO), and any mixture thereof.

Hexamethylenediamine derivative polymers: Suitable polymers includehexamethylenediamine derivative polymers, typically having the formula:

R₂(CH₃)N⁺(CH₂)6N⁺(CH₃)R₂. 2X⁻

wherein X⁻ is a suitable counter-ion, for example chloride, and R is a poly(ethylene glycol) chain having an average degree of ethoxylation of from 20 to 30. Optionally, the poly(ethylene glycol) chains may be independently capped with sulphate and/or sulphonate groups, typically with the charge being balanced by reducing the number of X⁻ counter-ions, or (in cases where the average degree of sulphation per molecule is greater than two), introduction of Y⁺ counter-ions, for example sodium cations.

### Enzymes

The consumer products can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a consumer product, the aforementioned additional enzymes may be present at levels from about 0.00001% to about 2%, from about 0.0001% to about 1% or even from about 0.001% to about 0.5% enzyme protein by weight of the consumer product.

In one aspect preferred enzymes would include a protease. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, U.S. Pat. No. 7,262,042 and WO09/021,867.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, including those derived from Bacillus amyloliquefaciens described in WO 07/044,993A2.

Preferred proteases include those derived from Bacillus gibsonii or Bacillus lentus.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

Suitable alpha-amylases include those of bacterial or fungal origin. Chemically or genetically modified mutants (variants) are included. A preferred alkaline alpha-amylase is derived from a strain of Bacillus, such as Bacillus lichenifonnis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:

26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.

(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.

(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

Suitable commercially available alpha-amylases include Duramyl®, Liquezyme®, Termamyl®, Termamyl Ultra®, Natalase®, Supramyl®, Stainzyme®, Stainzyme® Plus, Fungamyl® and BAN® (Novozymes A/S, Bagsvaerd, Denmark), Kemzyme® AT 9000 Biozym Biotech Trading GmbH Wehlistrasse 27b A-1200 Wien Austria, Rapidase®, Purastar®, Enzysize®, Optisize® HT PLUS and Purastar® Oxam (Genencor International Inc., Palo Alto, Calif.) and Kam® (Kao, 14-10 Nihonbashi Kayabacho, 1-chome, Chuo-ku Tokyo 103-8210, Japan). In one aspect, suitable amylases include Natalase®, Stainzyme® and Stainzyme® Plus and mixtures thereof.

In one aspect, such enzymes may be selected from the group consisting of: lipases, including “first cycle lipases” such as those described in U.S. Pat. No. 6,939,702 B1 and US PA 2009/0217464. In one aspect, the lipase is a first-wash lipase, preferably a variant of the wild-type lipase from Thermomyces lanuginosus comprising T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Preferred lipases would include those sold under the tradenames Lipex® and Lipolex®.

In one aspect, other preferred enzymes include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403B2) and mixtures thereof. Suitable endoglucanases are sold under the tradenames Celluclean® and Whitezyme®(Novozymes A/S, Bagsvaerd, Denmark).

Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, Calif.).

Surfactants—The consumer products according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject consumer product.

Suitable anionic detersive surfactants include sulphate and sulphonate detersive surfactants.

Suitable sulphonate detersive surfactants include alkyl benzene sulphonate, in one aspect, C₁₀₋₁₃ alkyl benzene sulphonate. Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Suitable sulphate detersive surfactants include alkyl sulphate, in one aspect, C₈₋₁₈ alkyl sulphate, or predominantly C₁₂ alkyl sulphate.

Another suitable sulphate detersive surfactant is alkyl alkoxylated sulphate, in one aspect, alkyl ethoxylated sulphate, in one aspect, a C₈₋₁₈ alkyl alkoxylated sulphate, in another aspect, a C₈₋₁₈ alkyl ethoxylated sulphate, typically the alkyl alkoxylated sulphate has an average degree of alkoxylation of from 0.5 to 20, or from 0.5 to 10, typically the alkyl alkoxylated sulphate is a C₈₋₁₈ alkyl ethoxylated sulphate having an average degree of ethoxylation of from 0.5 to 10, from 0.5 to 7, from 0.5 to 5 or even from 0.5 to 3.

The alkyl sulphate, alkyl alkoxylated sulphate and alkyl benzene sulphonates may be linear or branched, substituted or un-substituted.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, for example a mid-chain branched alkyl sulphate. In one aspect, the mid-chain branches are C₁₋₄ alkyl groups, typically methyl and/or ethyl groups.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein the alkoxylate units may be ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, in one aspect, alkylpolyglycosides; polyhydroxy fatty acid amides; ether capped poly(oxyalkylated) alcohol surfactants; and mixtures thereof.

Suitable non-ionic detersive surfactants include alkyl polyglucoside and/or an alkyl alkoxylated alcohol.

In one aspect, non-ionic detersive surfactants include alkyl alkoxylated alcohols, in one aspect C₈₋₁₈ alkyl alkoxylated alcohol, for example a C₈₋₁₈ alkyl ethoxylated alcohol, the alkyl alkoxylated alcohol may have an average degree of alkoxylation of from 1 to 50, from 1 to 30, from 1 to 20, or from 1 to 10. In one aspect, the alkyl alkoxylated alcohol may be a C₈₋₁₈ alkyl ethoxylated alcohol having an average degree of ethoxylation of from 1 to 10, from 1 to 7, more from 1 to 5 or from 3 to 7. The alkyl alkoxylated alcohol can be linear or branched, and substituted or un-substituted.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Builders—The consumer products of the present invention may comprise one or more detergent builders or builder systems. When a builder is used, the subject consumer product will typically comprise at least about 1%, from about 2% to about 60% or even from about 5% to about 10% builder by weight of the subject consumer product. The composition may even be substantially free of builder; substantially free means “no deliberately added” zeolite and/or phosphate. Typical zeolite builders include zeolite A, zeolite P and zeolite MAP. A typical phosphate builder is sodium tri-polyphosphate. Preferred compositions according to the invention comprise less than 10 wt % zeolite builder and less than 10 wt % phosphate builder, preferably less than 5 wt % zeolite builder and less than 5 wt % phosphate builder.

Chelating Agents—The consumer products herein may contain a chelating agent. Suitable chelating agents include copper, iron and/or manganese chelating agents and mixtures thereof. When a chelating agent is used, the subject consumer product may comprise from about 0.005% to about 15% or even from about 3.0% to about 10% chelating agent by weight of the subject consumer product. Suitable chelants include DTPA (Diethylene triamine pentaacetic acid), HEDP (Hydroxyethane diphosphonic acid), DTPMP (Diethylene triamine penta(methylene phosphonic acid)), 1,2-Dihydroxybenzene-3,5-disulfonic acid disodium salt hydrate, ethylenediamine, diethylene triamine, ethylenediaminedisuccinic acid (EDDS), N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof.

Dye Transfer Inhibiting Agents—The consumer products of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject consumer product, the dye transfer inhibiting agents may be present at levels from about 0.0001% to about 10%, from about 0.01% to about 5% or even from about 0.1% to about 3% by weight of the consumer product.

Brighteners—The consumer products of the present invention can also contain additional components that may tint articles being cleaned, such as fluorescent brighteners. Prefened classes of fluorescent brightener are: Di-styryl biphenyl compounds, e.g. Tinopal™ CBS-X, Di-amino stilbene di-sulfonic acid compounds, e.g. Tinopal™ DMS pure Xtra and Blankophor™ HRH, and Pyrazoline compounds, e.g. Blankophor™ SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl. It is preferred that the aqueous solution used in the method has a fluorescer present. When a fluorescer is present in the aqueous solution used in the method it is preferably in the range from 0.0001 g/l to 0.1 g/l, preferably 0.001 to 0.02 g/1.

A particularly preferred fluorescent brightener is C.I. Fluorescent Brightener 260 having the following structure. For solid detergent compositions, this brightener may be used in its beta or alpha crystalline forms, or a mixture of these forms.

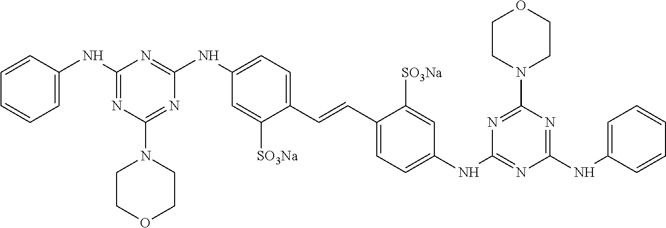

The brightener is typically in micronized particulate form, having a weight average primary particle size of from 3 to 30 micrometers, from 3 micrometers to 20 micrometers, or from 3 to 10 micrometers.

Suitable fluorescent brightener levels include lower levels of from about 0.01, from about 0.05, from about 0.1 or even from about 0.2 wt % to upper levels of 0.5 or even 0.75 wt %.

Silicate salts—The consumer products of the present invention can also contain silicate salts, such as sodium or potassium silicate. The composition may comprise from 0 wt % to less than 10 wt % silicate salt, to 9 wt %, or to 8 wt %, or to 7 wt %, or to 6 wt %, or to 5 wt %, or to 4 wt %, or to 3 wt %, or even to 2 wt %, and preferably from above 0 wt %, or from 0.5 wt %, or even from 1 wt % silicate salt. A suitable silicate salt is sodium silicate.

Dispersants—The consumer products of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzyme Stabilizers—Enzymes for use in consumer products can be stabilized by various techniques. The enzymes employed herein can be stabilized by the presence of water-soluble sources of calcium and/or magnesium ions in the finished fabric and home care products that provide such ions to the enzymes. In case of aqueous consumer products comprising protease, a reversible protease inhibitor, such as a boron compound, or compounds such as calcium formate, sodium formate and 1,2-propane diol can be added to further improve stability.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Suds suppressor: Suitable suds suppressors include silicone and/or fatty acid such as stearic acid.

Perfume: Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Aesthetics: Suitable aesthetic particles include soap rings, lamellar aesthetic particles, geltin beads, carbonate and/or sulphate salt speckles, coloured clay particles, and any combination thereof.

### Processes of Making Consumer Products

The consumer products of the present invention can be formulated into any suitable form and prepared by any process chosen by the formulator, non-limiting examples of which are described in Applicants' examples and in U.S. Pat. No. 4,990,280; U.S. 20030087791A1; U.S. 20030087790A1; U.S. 20050003983A1; U.S. 20040048764A1; U.S. Pat. No. 4,762,636; U.S. Pat. No. 6,291,412; U.S. 20050227891A1; EP 1070115A2; U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

The present invention includes a method of treating a surface, preferably a textile, comprising (i) forming an aqueous wash liquor comprising water and a composition according to any preceding claim; (ii) treating the textile with the aqueous wash liquor; and (iii) rinsing the surface.

As used herein, treating includes but is not limited to, washing including soaking, scrubbing, and mechanical agitation. Drying of such surfaces or fabrics may be accomplished by any one of the common means employed either in domestic or industrial settings.

As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer or institutional use conditions. The solution preferably has a pH of from about 8 to about 12, typically 9 to 10.5. The compositions may be employed at concentrations of generally from about 500 ppm to about 15,000 ppm in solution. The water temperatures typically range from about 5° C. to about 90° C. The water to fabric ratio is typically from about 1:1 to about 30:1.

### Test Methods

### Test Method 1: First Wash Lipase Test

### Lard First Wash Test

Whether any specific lipase enzyme gives better First Wash lard removal performance than WT Lipolase (from Novozymes, described in U.S. Pat. No. 5,869,438, SEQ ID:2), can be determined by comparing the performance results of WT Lipolase with the performance results of the specific lipase enzyme according to the following test:

The wash performance of lipolytic enzymes is tested in a one cycle wash trial carried out in a thermostated Terg-O-tometer (TOM) followed by line-drying. The experimental conditions are as follows:
Wash liquor: 1000 ml per beaker
Swatches: 7 flat cotton swatches (9×9 cm) (supplied by Warwick-Equest) per beaker
Stain: Lard coloured red with sudan red dye (Sigma) (0.75 mg Sudan red/g lard). 50 μl of lard/sudan red heated to 70° C. are applied to the centre of each swatch. After application of the stain the swatches are heated in an oven for 25 minutes at 75° C. and then stored overnight at room temperature.
Water for preparing wash liquor: 3.2 mM Ca²⁺/Mg²⁺ (in a ratio of 5:1)
Detergent: 5 g/l of detergent composition A.

### Detergent Composition A:

0.300 g/l alkyl sulphate (AS; C₁₄₋₁₆)
0.650 g/l of alcohol ethoxylate (AEO; C₁₂₋₁₄, 6EO)

### 1.750 g/l Zeolite P

### 0.145 g/l Na₂CO₃

### 0.020 g/l Sokalan CP5 (BASF)

0.050 g/l CMC (carboxy methyl cellulose—Finnfix BDA ex CP Kelco)
5 g/l of detergent composition A are mixed into deionised water with added hardness (3.2 mM Ca^{2±}/Mg²⁺ (5:1)) and the pH artificially adjusted to pH 10.2 by adding NaOH. Lipase enzyme is added.
Concentration of lipolytic enzyme: 0 and 12500 LU/l
Wash time: 20 minutes
Wash temperature: 30° C.
Rinse: 15 minutes in running tap water
Drying: overnight at room conditions (approx. 20° C., 30-40% RH).
Evaluation: the reflectance was measured at 460 nm.
The percentage of lard removed is determined as:
Delta reflectance (dR) defined as:
(R(Swatches washed in detergent with lipase)-R(Swatches washed in detergent without lipase)

The reflectance (which may also be termed remission) is measured on an Elrepho 2000 apparatus from Datacolor which illuminates the sample with 2 xenon blitz lamps and measures the amount of reflected light so that entirely white corresponds to a 100% reflectance and entirely black a 0% reflectance. Comparing the results for lard removal due to the presence of enzyme, lipase enzymes giving better performance than WT Lipolase™ are suitable for use in the compositions of the present invention.

### Test Method 2: Dissolution Test

Dissolution profiles are generated using a Copley tergotometer (Copley Scientific, Nottingham, U.K.), with water bath set at 30° C. and 200 rpm agitation, using a model wash liquor prepared by dissolving the following formulation at a concentration of 2 g/L in 12° dH water, and agitating the solution for 10 minutes prior to addition of the delayed release benefit agent particle. The 12° dH water was prepared using deionised water and addition of calcium chloride

(2 ml/L of 0.713M) and MgC12 (2 ml/L of 0.357M), and sodium bicarbonate (6 ml/L of 0.535M).

The delayed release kinetics of the particles according to the invention were measured using a ‘TA test method’ which measures the time taken to achieve a A % of the ultimate concentration of the benefit agent. The ultimate concentration is taken as being the concentration reached in the test after 1 hour dissolution time.

After addition of the delayed release particle, the concentration of the benefit agent released is measured every minute for the first five minutes then every five minutes for the remained of one hour. Percentage release after one minute and three minutes is then calculated, using the results to determine the rate, and sharpness of release of the particle. A suitable analytical method for a given active can be easily selected to someone skilled in the art. For example, for a dye benefit agent, electronic spectroscopy may be suitable with absorption taken at the lambda max of the dye; for a fluorescent brightening agent, fluorescence spectroscopy may be preferred. A variety of enzyme assays can be applied, such as those involving synthetic substrates, for example p-nitrophenyl butyrate (for lipase), p-nitroanilide peptides (for protease) or dyed polysaccharide-based substrates (for glycosyl hydrolases) such as those supplied by Megazyme (Bray, Republic of Ireland).

### EXAMPLES

Unless otherwise indicated, materials can be obtained from Aldrich, P.O. Box 2060, Milwaukee, Wis. 53201, USA.

### Example 1

A coated lipase was prepared as follows. The lipase was Lipex™ (product of Novozymes A/S, described in WO 00/60063). It was formulated as a T-granulate produced essentially as in example 1 of WO 2004/003188 (Int'l Appl. No. PCT/DK03/000456) (containing enzyme, Na-sulfate, cellulose fibers, calcium carbonate and a binder, e.g. sucrose or dextrin). This was coated with a coating consisting of 31% of palm oil, 50% of kaolin or calcium carbonate and 19% of titanium dioxide (% by weight). The amount of the coating material made up 25% by weight of the coated granules.

| | In core | In outer coating | Total |
|---|---|---|---|
| Ingredient | (wt %) | (wt %) | (wt %) |
| Sodium sulfate | 67 | | 49 |
| Kaolin | 9 | 50 | 19 |
| Cellulose | 10 | | 8 |
| Dextrin | 3 | | 2 |
| Sucrose | 2 | | 2 |
| Lipase (and other dry | 9 | | 7 |
| matter from concentrate) | | | |
| Palm oil | | 31 | 8 |
| Titanium dioxide | | 19 | 5 |

### Example 2

### Washing Tests with Coated Lipase and Organic Catalyst

The wash performance and the resistance to organic catalyst of the coated lipase were tested in washing tests with a model detergent (described below) using textile swatches soiled with various fatty stains (also described below).

The invention formulation was the coated lipase granulate prepared in Example 1. For comparison, the same lipase in the form of a conventional granulate coated with PEG (polyethylene glycol) was used as a conventional formulation. The organic bleach catalyst was a compound according to Formula I in WO 2007/001262 with R¹=2-butyl-octyl.

### Experimental Conditions

| Machine | Miele Softtronic W2245 (EU) | | | |
|---|---|---|---|---|
| Program | Minimum Iron, Water Plus, approx 15 L water | | | |
| Temperature | 30° C. | | | |
| Water | Water hardness Wash: 18dH (molar ratio between | | | |
| hardness | Ca²⁺/Mg²⁺/HCO3⁻ 4:1:7.5) | | | |
| Test | LAS | 0.9 g/l | | |
| detergent | AEO | 0.2 g/l | | |
| | Na2CO3 | 0.53 g/l | | |
| | Zeolite A4 | 1.07 g/l | | |
| | Na3citrate | 0.52 g/l | | |
| | Percarbonate | 1 g/l | | |
| | TAED | 0.25 g/l | | |
| | Bleach catalyst | −/+125 mg/l (2.5 ppm active) | | |
| pH | As is | | | |
| Swatches/ | 2 of each of the below stains attached | | | |
| test | to tea-towels in 3 corners | | | |
| | | | Manufac- | Measure- |
| material | Substrate | Product code | turer | ments |
| | Mustard | CS67 | CFT | Color eye, |
| | | (4 × 9 cm) | | Reflectance, |
| | | | | 540 nm |
| | Hamburger | 10 × 10 cm | Equest | Scanner, |
| | grease | blue knitted | | Intensity |
| | Lard | cotton, Stain | | |
| | Margarine | diameter 5 cm | | |
| | Bacon | | | |
| | grease | | | |
| | Butter | | | |

| | |
|---|---|
| Drying | Lying flat on blotting paper, 24 h, |
| | room temperature, in dark |
| Ballast | 2.7 kg cotton ballast |
| Enzymes | Dosage 0.25 mg enzyme protein (EP)/l |
| Repetitions | 3 repeated washes per condition |

### Wash Performance Evaluation of Blue Equest Stains

The wash performance of the blue Equest stains is measured after 24 hours+/−2 hours of drying as the brightness of the color of the textile washed. Brightness can also be expressed as the intensity of the light reflected from the sample when illuminated with white light. When the sample is stained the intensity of the reflected light is lower than that of a clean sample. Therefore the intensity of the reflected light can be used to measure wash performance.

Color measurements are made with a professional flatbed scanner (Kodak iQsmart, Kodak, Midtager 29, DK-2605 Brøndby, Denmark), which is used to capture an image of the washed textile.

To extract a value for the light intensity from the scanned images, 24-bit pixel values from the image are converted into values for red, green and blue (RGB). The scans are made with a resolution of 200 dpi.

The intensity value (Int) is calculated by adding the RGB values together as vectors and then taking the length of the resulting vector:

Int=\sqrt{r²+g²+b²}.

The wash performance (P) of the lipase formulation is calculated in accordance with the below formula:

P=ΔInt=Int(v)−Int(r)

where

Int(v) is the light intensity value of textile surface washed with the lipase formulation, and

Int(r) is the light intensity value of textile surface washed without the lipase formulation.

### Wash Performance Evaluation of CS67

Wash performance is expressed as a delta remission value (ΔRem). Light reflectance evaluations of the swatches were done after 24 hours of drying using a Macbeth Color Eye 7000 reflectance spectrophotometer with very small aperture. The measurements were made without UV in the incident light and remission at 540 nm was extracted. Measurements were made on washed swatches. The test swatch to be measured was placed on top of another swatch of same type and color (twin swatch).

P=ΔREM=Rem(v)−Rem(r)

where

Rem(v) is the light intensity value of textile surface washed with the lipase formulation, and

Rem(r) is the light intensity value of textile surface washed without the lipase formulation.

Calculation of Relative Performance score

A relative performance score is given as the result of the full scale was washed in accordance with the definition:

Relative Performance scores (RP) give performance (P) of the tested lipase formulation against the conventional lipase formulation:

RP=P(invention formulation)/P(conventional formulation).

RPavg indicates the average relative performance compared to the conventional lipase formulation on each swatch type at all repetitions (3 repeated washes with 2 stains in each wash)

A lipase formulation is considered to exhibit improved wash performance, if it performs better than the conventional lipase formulation.

The resistance of the lipase formulation against the bleach catalyst is calculated in accordance with the below formulation

### Calculation of Residual Performance Score (ResP)

Residual performance score (ResP) is calculated as the performance (P) of the tested lipase formulation with the bleach catalyst relative to the tested lipase formulation without the bleach catalyst:

ResP=P(invention formulation with bleach catalyst)/P(invention formulation without bleach catalyst).

ResPavg indicates the average relative performance compared to the conventional lipase formulation on each swatch type at all repetitions (3 repeated washes with 2 stains in each wash).

An improvement factor was taken as ResPavg for the invention formulation relative to the conventional formulation. A lipase formulation exhibits improved resistance towards the bleach catalyst if it has higher residual performance than the conventional lipase formulation.

### Results

| | | Equest stains | | | | | | CFT |
|---|---|---|---|---|---|---|---|---|
| | | Hamburger | | | Bacon | | Avg | stain |
| | | grease | Lard | Margarine | grease | Butter | Equest | CS67 |
| % ResPavg | Invention | 22 | 47 | 60 | 58 | 38 | 45 | 59 |
| with 2.5 ppm | formulation | | | | | | | |
| Bleach | Conventional | 0 | 25 | 20 | 8 | 26 | 16 | 37 |
| catalyst | formulation | | | | | | | |
| Improvement | | NA | 1.9 | 2.9 | 7.0 | 1.4 | 3.3 | 1.6 |
| factor with | | | | | | | | |
| 2.5 ppm | | | | | | | | |
| Bleach | | | | | | | | |
| catalyst | | | | | | | | |
| RPavg (%) | Lipex DR/ | 117 | 95 | 120 | 68 | 80 | 96 | 106 |
| | Lipex 100T | | | | | | | |

The results for ResPavg for the conventional formulation are all 37% or less, indicating that the lipase is sensitive to the bleach catalyst.

The results for the improvement factor demonstrate that the lipase in the form of granules with a delayed-release coating is markedly less inhibited by the organic bleach catalyst than conventional granules. On average, the lipase with delayed-release coating was inhibited by 49-56% while the conventional granules were inhibited by 65-85%.

The results for RPavg demonstrate that the lipase performance of granules with delayed-release coating broadly matches that of conventional lipase granules although there is high variation in the performance values on the individual stains for both of the lipase samples.

### Examples 3-8

Granular laundry detergent compositions designed for hand washing or top-loading washing machines.

| | 3 | 4 | 5 | 6 | 7 | 8 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.5 | 0.9 |
| AE7 | 0.0 | 0.0 | 0.0 | 1 | 0.0 | 3 |
| Sodium tripolyphosphate | 5 | 0.0 | 4 | 9 | 2 | 0.0 |
| Zeolite A | 0.0 | 1 | 0.0 | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer | 0.1 | 0.2 | 0.0 | 0.0 | 0.0 | 0.0 |
| Carboxymethyl cellulose | 1 | 0.3 | 1 | 1 | 1 | 1 |
| Stainzyme ™ Plus (20 mg | 0.1 | 0.2 | 0.1 | 0.2 | 0.1 | 0.1 |
| active/g) | | | | | | |
| Savinase ™, 32.89 mg active/g | 0.1 | 0.1 | 0.1 | 0.1 | | 0.1 |
| Natalase ™ (8.65 mg active/g) | 0.1 | 0.0 | 0.1 | 0.0 | 0.1 | 0.1 |
| Lipex ™ (18 mg active/g) | 0.03 | 0.07 | 0.3 | 0.1 | 0.07 | 0.4 |
| Delayed Lipex ™ of Example | 0.03 | 0.1 | 0.3 | 0.1 | 0.2 | 0.5 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate | 4.4 | 0.0 | 3.85 | 2.09 | 0.78 | 3.63 |
| Monohydrate | | | | | | |
| NOBS | 1.9 | 0.0 | 1.66 | 0.0 | 0.33 | 0.75 |
| TAED | 0.58 | 1.2 | 0.51 | 0.0 | 0.015 | 0.28 |
| Sulphonated zinc | 0.0030 | 0.0 | 0.0012 | 0.0030 | 0.0021 | 0.0 |
| phthalocyanine | | | | | | |
| S-ACMC | 0.1 | 0.0 | 0.0 | 0.0 | 0.06 | 0.0 |
| Direct Violet 9 | 0.0 | 0.0 | 0.0003 | 0.0005 | 0.0003 | 0.0 |
| Acid Blue 29 | 0.0 | 0.0 | 0.0 | 0.0 | 0.0 | 0.0003 |

| | |
|---|---|
| Sulfate/Moisture | Balance |

### Examples 9-14

Granular laundry detergent compositions designed for front-loading automatic washing machines.

| | 9 | 10 | 11 | 12 | 13 | 14 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 0 | 5.2 | 4 | 4 |
| C12-14 Alkylsulfate | 1 | 0 | 1 | 0 | 0 | 0 |
| AE7 | 2.2 | 0 | 3.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate | 4.1 | 0 | 4.8 | 0 | 0 | 0 |
| (δ-Na₂Si₂O₅) | | | | | | |
| Zeolite A | 5 | 0 | 5 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio | 0.08 | 0 | 0.11 | 0 | 0 | 0 |
| 2:1) | | | | | | |
| Soil release agent | 0.75 | 0.72 | 0.71 | 0.72 | 0 | 0 |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Savinase ™, 32.89 mg active/g | 0.4 | 0.4 | 0.5 | 0.3 | 0.2 | 0.2 |
| Stainzyme ™ Plus (20 mg | 0.2 | 0.15 | 0.2 | 0.3 | 0.15 | 0.15 |
| active/g) | | | | | | |
| Lipex ™ (18.00 mg active/g) | 0 | 0.05 | 0 | 0 | 0 | 0 |
| Natalase ™ (8.65 mg active/g) | 0.1 | 0.2 | 0 | 0 | 0.15 | 0.15 |
| Celluclean ™ (15.6 mg active/g) | 0 | 0 | 0 | 0 | 0.1 | 0.1 |
| Delayed Lipex ™ of Example 1 | 0.2 | 0.1 | 0.3 | 0.2 | 0.3 | x |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulphonated zinc phthalocyanine | 0.0007 | 0.0012 | 0.0007 | 0 | 0 | 0 |
| (active) | | | | | | |
| S-ACMC | 0.01 | 0.01 | 0 | 0.01 | 0 | 0 |
| Direct Violet 9 (active) | 0 | 0 | 0.0001 | 0.0001 | 0 | 0 |

| | |
|---|---|
| Sulfate/Water & Miscellaneous | Balance |

Any of the above compositions is used to launder fabrics at a concentration of 7000 to 10000 ppm in water, 20-90° C., and a 5:1 water:cloth ratio. The typical pH is about 10. The fabrics are then dried. In one aspect, the fabrics are actively dried using a dryer. In one aspect, the fabrics are actively dried using an iron. In another aspect, the fabrics are merely allowed to dry on a line wherein they are exposed to air and optionally sunlight.

### Raw Materials and Notes for Composition Examples 3-14

Linear alkylbenzenesulfonate having an average aliphatic carbon chain length C₁₁-C₁₂ supplied by Stepan, Northfield, Ill., USA

C₁₂₋₁₄ Dimethylhydroxyethyl ammonium chloride, supplied by Clariant GmbH, Sulzbach, Germany

AE3S is C₁₂₋₁₅ alkyl ethoxy (3) sulfate supplied by Stepan, Northfield, Ill., USA

AE7 is C₁₂₋₁₅ alcohol ethoxylate, with an average degree of ethoxylation of 7, supplied by Huntsman, Salt Lake City, Utah, USA

Sodium tripolyphosphate is supplied by Rhodia, Paris, France

Zeolite A is supplied by Industrial Zeolite (UK) Ltd, Grays, Essex, UK

1.6R Silicate is supplied by Koma, Nestemica, Czech Republic

Sodium Carbonate is supplied by Solvay, Houston, Tex., USA

Polyacrylate MW 4500 is supplied by BASF, Ludwigshafen, Germany

Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. It is supplied by BASF, Ludwigshafen, Germany.

Carboxymethyl cellulose is Finnfix® V supplied by CP Kelco, Arnhem, Netherlands

Diethylenetetraamine pentaacetic acid (DTPA) is supplied by Dow Chemical, Midland, Mich., USA

Hydroxyethane di phosphonate (HEDP) is supplied by Solutia, St Louis, Mo., USA Bagsvaerd, Denmark

Na salt of Ethylenediamine-N,N′-disuccinic acid, (S,S) isomer (EDDS), is supplied by Innospec, Ellesmere Port, United Kingdom.

Savinase™, Natalase™, Stainzyme™ Plus, Lipex™ and Celluclean™ are all products of Novozymes, Bagsvaerd, Denmark.

Fluorescent Brightener 1 is Tinopal® AMS, Fluorescent Brightener 2 is Tinopal® CBS-X, Sulphonated zinc phthalocyanine and Direct Violet 9 is Pergasol® Violet BN-Z all supplied by Ciba Specialty Chemicals, Basel, Switzerland

Sodium percarbonate supplied by Solvay, Brussels, Belgium

Sodium perborate is supplied by Evonik, Hanau, Germany

NOBS is sodium nonanoyloxybenzenesulfonate, supplied by Future Fuels, Batesville, Ark., USA

TAED is tetraacetylethylenediamine, supplied under the Peractive® brand name by Clariant GmbH, Sulzbach, Germany

S-ACMC is carboxymethylcellulose conjugated with C.I. Reactive Blue 19, sold by Megazyme, Wicklow, Ireland under the product name AZO-CM-CELLULOSE, product code S-ACMC.

Soil release agent is Repel-o-tex® SF2, supplied by Rhodia, Paris, France

Acrylic Acid/Maleic Acid Copolymer is molecular weight 70,000 and acrylate:maleate ratio 70:30, supplied by BASF, Ludwigshafen, Germany

Suds suppressor agglomerate is supplied by Dow Corning, Midland, Mich., USA

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
a) a bleach component,
b) a protected particle comprising a sensitive component;
c) a first wash lipid esterase; and
d) a detergent adjunct,
wherein the protected particle comprises a substrate for said first wash lipid esterase.

2. A detergent composition according to claim 1 wherein the sensitive component comprises an enzyme.

3. A detergent composition according to claim 2 wherein the sensitive component comprised in the protected particle comprises said first wash lipid esterase.

4. A particulate detergent composition comprising:
a) first particles comprising a first bleach component, and
b) second particles comprising a second bleach component; and
c) third, protected particles comprising
i) a core comprising an enzyme surrounded by
ii) a delayed-release coating; and
d) a detergent adjunct.

5. A particulate detergent composition according to claim 4 comprising:
a) first particles comprising a first bleach component, and
b) particles comprising a second bleach component comprising a bleach catalyst, and
c) protected particles comprising
i) a core comprising an enzyme which is a first-wash lipid esterase surrounded by
ii) a delayed-release coating and
d) a detergent adjunct.

6. A particulate detergent composition according to claim 4 wherein the first bleach component comprises a source of organic peroxyacids and the second bleach component comprises an organic bleach catalyst.

7. A detergent composition according to claim 1 wherein the protected particle comprises:
i) a core and
ii) at least a first coating layer; and
iii) optional second and further coating layers;
wherein at least one of the core or coating layers comprises the sensitive component and at least one coating layer outermost with respect to the sensitive component, comprises a delayed-release coating comprising the substrate for the first wash lipid esterase.

8. A detergent composition according to claim 4 wherein the protected particle comprises:
i) a core and
ii) at least a first coating layer; and
iii) optional second and further coating layers;
wherein at least one of the core or coating layers comprises the sensitive component and at least one coating layer outermost with respect to the sensitive component, comprises a delayed-release coating comprising the substrate for the first wash lipid esterase.

9. A detergent composition according to claim 4 wherein the enzyme comprises a first wash lipid esterase and the substrate for the first wash lipase esterase comprises lipids, mono-, di- and triglycerides such as tripalmitin, palm oil, beeswax, jojoba oil, carnauba wax, carnauba wax, polyesters, polyester block copolymers such as polyethylene terephthalate/polyoxyethylene terephthalate (PET/POET) block copolymers and polycaprolactone.

10. A detergent composition according to claim 2 wherein the enzyme comprises a first wash lipid esterase and the substrate for the first wash lipase esterase comprises lipids, mono-, di- and triglycerides such as tripalmitin, palm oil, beeswax, jojoba oil, carnauba wax, carnauba wax, polyesters, polyester block copolymers such as polyethylene terephthalate/polyoxyethylene terephthalate (PET/POET) block copolymers and polycaprolactone.

11. A detergent composition according to claim 1 wherein the sensitive component comprises a fabric hueing dye or optical brightener.

12. A detergent composition according claim 1 wherein the sensitive component comprises an ester perfume component or mixtures thereof.

13. A detergent composition according to claim 1 wherein the first wash lipid esterase is an enzyme selected from the group consisting of triacylglycerol lipases (E.C. 3.1.1.1) exhibiting first wash activity, cutinases (E.C.3.1.1.74), sterol esterases (E.C. 3.1.1.13) and wax-ester hydrolases (E.C.3.1.1.50) or mixtures thereof, preferably lipase.

14. A detergent composition according to claim 1 wherein the first wash lipid esterase enzyme comprises a lipase selected from variants of Humicola Lanuginosa lipase variants having the mutations T231R and N233R.

15. A cleaning composition according to claim 1 wherein the first wash lipid esterase enzyme comprises a cutinase, preferably selected from the variants of Pseudomonas mendocina cutinase or Humicola insolens cutinase and mixtures thereof.

16. A detergent composition according to claim 1 wherein the bleach component is selected from organic bleach catalysts, metal-containing bleach catalysts and pre-formed peracids and mixtures thereof.

17. A detergent composition according to claim 16 wherein the bleach catalyst is selected from those that comprise an iminium and/or carbonyl functional group and is capable of forming an oxaziridinium and/or dioxirane functional group upon acceptance of an oxygen atom.

18. A detergent composition according to claim 1 additionally comprising a fabric hueing dye.

19. A detergent composition according to claim 1 in the form of a unitized dose capsule.

20. A method of treating a textile, comprising (i) forming an aqueous wash liquor comprising water and a composition according to claim 4; (ii) treating the textile with the aqueous wash liquor; and (iii) rinsing the surface.
